(19) United States
(12) Patent Application Publication
(10) Pub. No.: US 2026/0065781 A1
(43) Pub. Date: Mar. 5, 2026

(54) VEHICLE RECOMMENDATION SYSTEM FOR CARBON MINIMIZATION

(71) Applicant: Toyota Research Institute, Inc., Los Altos, CA (US)

(72) Inventors: Rumen Iliev, Millbrae, CA (US); Chi Zhang, Palo Alto, CA (US); Vijay Thamalla, Arlington, TX (US)

(73) Assignees: Toyota Research Institute, Inc., Los Altos, CA (US); Toyota Jidosha Kabushiki Kaisha, Toyota-shi (JP)

(21) Appl. No.: 18/817,949

(22) Filed: Aug. 28, 2024

(51) Int. Cl. G06Q 30/018

(52) U.S. Cl. CPC G06Q 30/018

(57) ABSTRACT

Systems and methods described herein relate to determining a selection zone, generating a preference map associated with the selection zone, determining a vehicle preference score associated with a vehicle, and determining an available area within the selection zone for vehicle storage based on the vehicle preference score. The systems and methods described herein may further relate to adjusting the vehicle preference score based on the estimated environmental impact of a vehicle, the expected route of a vehicle user, or other factors.

### TECHNICAL FIELD

The subject matter described herein relates, in general, to strategies for encouraging vehicle selection in order to minimize environmental impact.

### BACKGROUND

Households often have a large number of transportation choices available to them. For example, in addition to any available public transportation services, a household may have multiple vehicles such as cars, SUVs, pick-up trucks, vans, motorcycles, scooters, bicycles, etc. that are powered by a motor or engine fueled by an energy source (e.g., battery, gasoline, diesel, hydrogen). Some vehicles may even have hybrid capabilities by allowing for the use of more than one energy source. Each vehicle when operated has an environmental impact, such as the generation of carbon dioxide or other pollutants. Such environmental impact may occur when the energy source is created (e.g., coal power), when the energy is consumed (e.g., combustion of petroleum products), or arise from other aspects relating to vehicle operation (e.g., tire particulate from tire wear). Further, each member of the household may only have a limited understanding of environmental impact, including fuel or energy efficiency.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to determine a selection zone, generate a preference map associated with the selection zone, determine a vehicle preference score associated with a vehicle, and determine an available area within the selection zone for vehicle storage based on the vehicle preference score.

In one embodiment, a non-transitory computer-readable medium including instructions that when executed by one or more processors cause the one or more processors to perform one or more functions is disclosed. The instructions include instructions to determine a selection zone, generate a preference map associated with the selection zone, determine a vehicle preference score associated with a vehicle, and determine an available area within the selection zone for vehicle storage based on the vehicle preference score.

In one embodiment, a method is disclosed. In one embodiment, the method includes determining a selection zone, generating a preference map associated with the selection zone, determining a vehicle preference score associated with a vehicle, and determining an available area within the selection zone for vehicle storage based on the vehicle preference score.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a vehicle selection system that is associated with vehicle selection strategies.

FIG. 3 illustrates one embodiment of a cloud computing environment within which the systems and methods described herein may operate.

FIG. 4 illustrates one example of a vehicle selection database.

FIG. 5 illustrates one example of vehicle selection administration areas.

FIG. 6 illustrates one example of implementing a preference map.

FIG. 7 illustrates one example of implementing a vehicle selection strategy.

FIG. 8 illustrates one example of a method for vehicle selection strategies.

### DETAILED DESCRIPTION

Systems, methods, and other embodiments associated with encouraging vehicle selection in order to minimize environmental impact are described herein. As members of a household often have limited knowledge regarding the environmental impact of their vehicles, they often fail to coordinate vehicle usage in a manner that minimizes environmental impact. For example, households often distribute vehicles in accordance with the age of the vehicle (e.g., parents get newer vehicles while teenagers or young adults get older vehicles) regardless of how much or what type of driving is performed by a household member. For example, if a car originally purchased to transport multiple members of the household is given to a household member that will use it as a food delivery vehicle, the environmental impact of the household as a whole may significantly increase. Generally, there is a lack of tools available to help members of a household evaluate the environmental impact of their vehicles other than individual metrics supplied by a vehicle (e.g., MPG, MPGe). In addition, coordinating vehicle usage between different members of the household can be a difficult task due to the different schedules and activities each member of the household may have.

In view of the above problem, systems and methods herein present ways for tracking vehicle usage, driver behavior, environmental impact, and other factors, which are then used for vehicle selection strategies. For example, based on information about a likely vehicle operator, the systems and methods may place a vehicle in a position of likely acceptance, such as on the driveway closest to the front entrance. In addition, the systems and methods may undertake actions to discourage alternative selections, such as leaving vehicles with a higher environmental impact parked in a closed garage. In some instances, the system may take into account different contexts in which to minimize environmental impact. For example, energy shortages via the power grid may cause the systems and methods to select vehicles less likely to require charging, but still offer some degree of lesser environmental impact (e.g., a hybrid vehicle). Furthermore, the types of environmental impact may also be adjusted, such as optimizing to minimize a particular pollutant (e.g., ozone, nitrogen oxides, tire particulate). Accordingly, if local environmental restrictions are imposed (e.g., ultra-low emissions zone), the systems and methods herein may take into account and encourage selection of vehicles that will minimize such pollutants, including where such restrictions only exist in an area outside of the household (e.g., a downtown area in which one of the household members will be traveling).

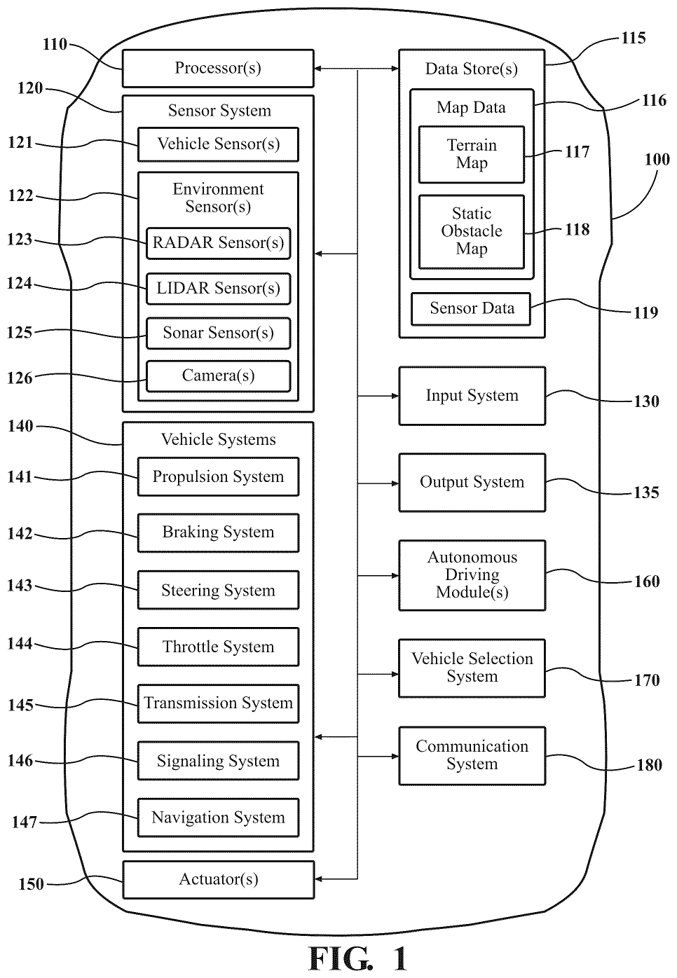

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with diagnostic charging strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

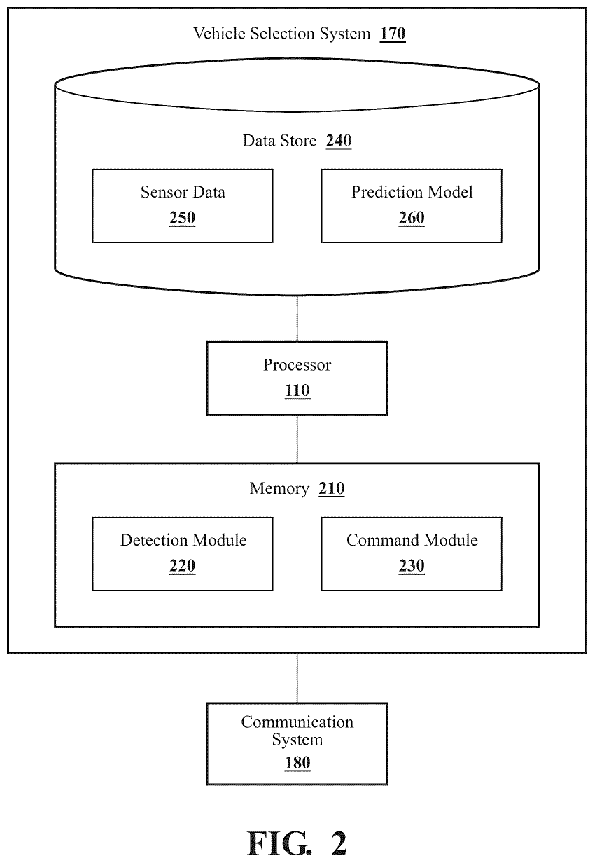

Some of the possible elements of vehicle 100 are shown in FIG. 1 and will be described along with subsequent figures. However, a description of many of the elements in FIG. 1 will be provided after the discussion of FIGS. 2-8 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a vehicle selection system 170 that is implemented to perform methods and other functions as disclosed herein relating to cooperative wildlife monitoring and reducing wildlife risks to vehicles or vice versa. As will be discussed in greater detail subsequently, vehicle selection system 170, in various embodiments, is implemented partially within vehicle 100 and as a cloud-based service. For example, in one approach, functionality associated with at least one module of vehicle selection system 170 is implemented within vehicle 100 while further functionality is implemented within a cloud-based computing system.

With reference to FIG. 2, one embodiment of vehicle selection system 170 of FIG. 1 is further illustrated. Vehicle selection system 170 is shown as including processor(s) 110 from vehicle 100 of FIG. 1. Accordingly, processor(s) 110 may be a part of vehicle selection system 170, vehicle selection system 170 may include a separate processor from processor 110(s) of vehicle 100, or vehicle selection system 170 may access processor 110(s) through a data bus or another communication path. In one embodiment, vehicle selection system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Vehicle selection system 170 as illustrated in FIG. 2 is generally an abstracted form of vehicle selection system 170 as may be implemented between vehicle 100 and a cloud-computing environment. Accordingly, vehicle selection system 170 may be embodied at least in part within a cloud-computing environment to perform the methods described herein.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allows for the detection of wildlife objects. For example, wildlife objects may be comprised of any sensor data 250 that may be relevant to the determination of animal presence or behavior, such as observations of animals through visual or audio sensors, detection of food, cover, or habitat, or other factors as described herein.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, vehicle selection system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to obtain battery measurements as described herein. In some embodiments, detection module 220 may receive and store battery measurements.

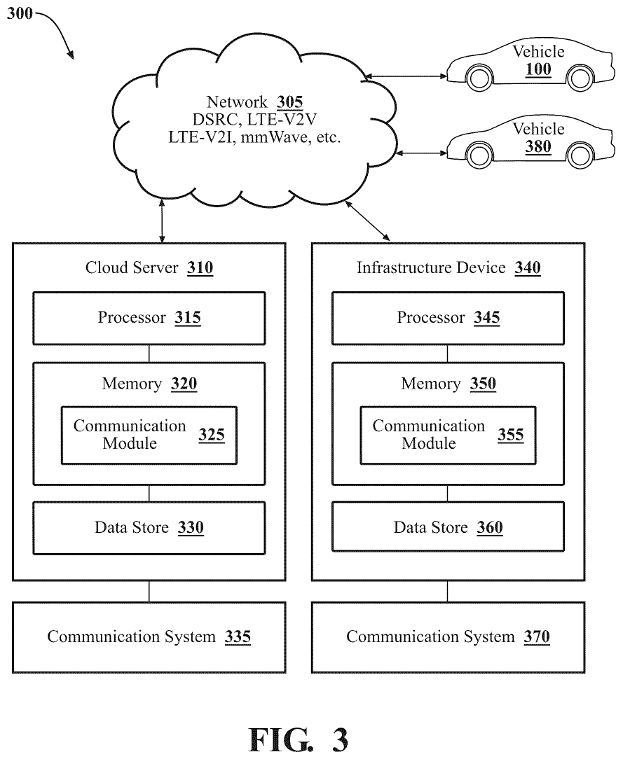

In one embodiment, command module 230 generally includes instructions that function to control the processor(s) 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of vehicle selection system 170 through network 305 via communication unit 335. In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of vehicle selection system 170 through network 305 via communication unit 370. In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, vehicle selection system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

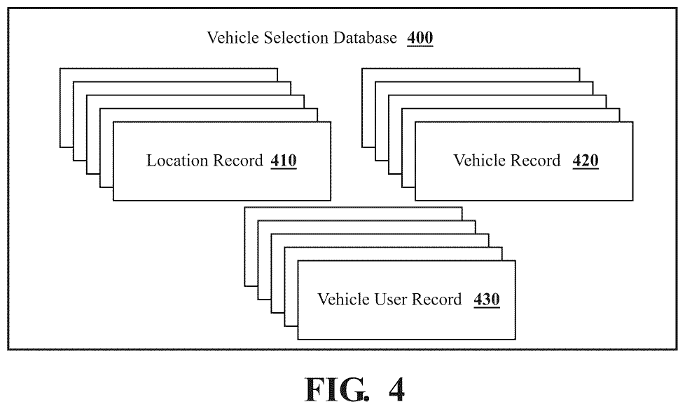

With respect to FIG. 4, an example of a vehicle selection database 400 is shown. Vehicle selection database 400 may be a general repository of vehicle selection related data that resides for example within cloud-computing environment 300. For any vehicle of interest, a vehicle record 410 may be generated and stored to describe various characteristics of a vehicle as described below. In addition, for any location of interest, a location record 420 may be generated and stored to describe various characteristics of a location as described below. Similarly, for any vehicle user of interest, a vehicle user record 430 may be generated and stored to describe various characteristics of the vehicle user as described below.

Each vehicle record 410 may contain, for example: entries related to vehicle type and configuration; entries related to the current or prior status of a vehicle, such as odometer readings, fuel/energy levels, fuel/energy efficiencies, current/past locations, current/past routes, engine hours, last oil change, battery health data, estimated tire life, etc.: entries related to functional restrictions constraining vehicle operation (e.g., vehicle can only be used for business purposes; vehicle cannot be used on highway; vehicle cannot be used in a ultra-low emission zone); entries related to sensor data, models, estimates, or other data that may be used to determine or predict the environmental impact of a vehicle; entries related to usage characteristics, such who typically operate the vehicle at a given time, what purpose the vehicle is used for, how many passengers may be present in a vehicle, or other data that may be used to determine or predict vehicle usage patterns; entries relating to vehicle preference settings, such as where the vehicle should be parked when at a given location; and so on.

Location record 420 may contain, for example: entries relating to geographic area/locations, such as GPS coordinates, property addresses, property records, plat map, surveys, geographic information system data, etc. ; entries relating to allowable vehicle areas within or at a geographic area/locations, such as driveways, garages, vehicle lifts, parking lots, etc. ; entries relating to vehicle restrictions within or at a geographic area/locations, such as restrictions relating to vehicle operator (e.g., handicap only), vehicle type (e.g., motorcycles only), vehicle actions (e.g., no parking, no standing); entries relating to location preference settings, such as where vehicles should be parked in preference to other areas (e.g., park vehicles on the northern side of the driveway first, closest to the house); and so on.

Each vehicle user record 430 may contain, for example: entries relating to the identity and characteristics of a vehicle user, such as name, driver's license/registration number, height, weight, biometrics, etc. ; entries relating to vehicle user preferences, such as preferred vehicle settings, temperature settings, preferred language, preferred exposure to direct sunlight; preferred privacy settings, etc. ; entries relating to vehicle user activities, such as daily/weekly/monthly schedules, calendar entries, meeting locations, social commitments, sleep records, etc. ; entries relating to vehicle user behavior, such as preferred approaches to navigation and routing, reactions to adverse events (e.g., traffic jams, accidents), etc. ; entries associating a vehicle user with particular vehicles, locations, or other vehicle users; and so on.

While examples herein have been given with respect to using vehicle selection database 400 to provide vehicle selection strategies for a household, it should be understood that usage of the term “household” is merely exemplary and other groups of people besides households (e.g., the staff working at a store as a “household”) may utilize vehicle selection database 400 to provide vehicle selection strategies as described herein. In addition, while examples herein are given with respect to vehicle records, location records, and vehicle user records, such records may be merged together, placed within each other, cross-linked, and so on with each other in vehicle selection database 400.

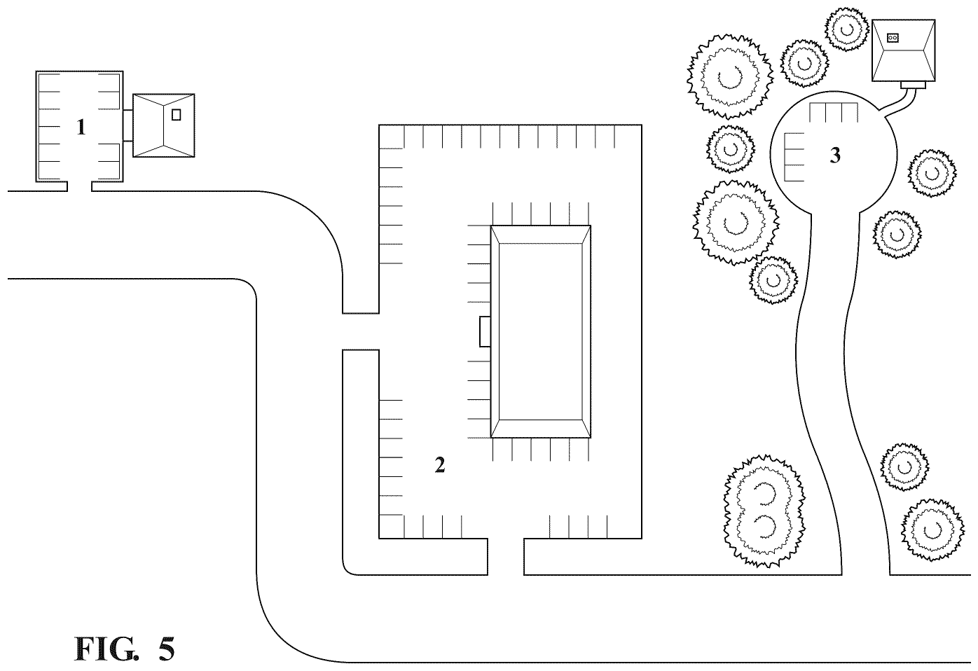

In some embodiments, command module 230 may determine a vehicle selection administration area (or “selection zone”) in relation to vehicle 100. For example, as shown in FIG. 5 vehicle 100 may participate in a first vehicle selection administration area at a household where the vehicle is typically kept, a second vehicle selection administration area at a store where the vehicle is often driven by a member of the household who is also an employee of the store, and a third temporary vehicle selection administration area at a vacation rental being used for a weekend family getaway by the household member. In some embodiments, a vehicle selection administration area may be determined automatically by command module 230, such as where command module 230 determines the location/area of a driveway from the street to a structure based on sensor data 250 (e.g., using location mapping derived from vehicle camera images). In some embodiments, a vehicle selection administration area may be entered based on information provided by a vehicle user or a third party. For example, a vehicle user may use a smartphone app to map out where the vehicle selection administration area is located, which is then submitted to command module 230. Once the vehicle selection administration area is generated or received by command module 230, it may be saved in a location record 420 associated with the location of the vehicle selection administration area. In some embodiments, multiple vehicle selection administration areas may overlap due to the presence of multiple households at a location, which may be administered separately or jointly by command module 230 depending on, for example, whether such households share members in common.

When a vehicle enters a vehicle selection administration area, command module 230 may determine whether such a vehicle is subject to vehicle selection strategies described herein for that vehicle selection administration area. For example, command module 230 may automatically determine that a vehicle is subject or not subject to vehicle selection strategies because of a vehicle type (e.g., emergency vehicle); vehicle activity (e.g., vehicle being washed on the driveway); lack of vehicle association with the vehicle selection administration area (e.g., the vehicle, it's vehicle user, or both are not connected to the household associated with the vehicle selection administration area); and so on. In some embodiments, command module 230 may receive instructions indicating that a vehicle or group of vehicles are not subject to vehicle selection strategies for that vehicle selection administration area. For example, a household may instruct that only vehicles not routinely in use (e.g., recreational vehicles) are subject to the vehicle selection administration area. Once a vehicle is determined to be subject or not subject to a vehicle selection administration area, such a determination may be recorded in vehicle selection database 400, such as in a vehicle record 410, location record 420, etc.

In some embodiments even if a vehicle would normally be subject to a vehicle selection administration area, such a designation may be temporarily suspended due to a vehicle user being associated with the vehicle. For example, a VIP vehicle user record may indicate that the last vehicle used by the VIP vehicle user is not subject to a vehicle selection administration area until the VIP vehicle user selects a different vehicle to operate.

In some embodiments, once the borders of a vehicle selection administration area is determined, command module 230 may generate a preference map with respect to where vehicles may be parked or stand by. For example, command module 230 may construct a preference map where numerical values for specific points or areas within the vehicle selection administration area indicate the desirability of that location for vehicle parking or standby (which may be described as a place to store the vehicle). For example, command module 230 may determine that areas closest to an entrance have a higher value within the preference map for a vehicle selection administration area, while areas further from the entrance have a lower value within the preference map. As another example, command module 230 may evaluate the behavior of vehicle users with respect to where they prefer to leave or position vehicles in the vehicle selection administration area to generate a preference map. As such, if for instance vehicle users are preferring to park in the shade of a tree rather than near the entrance, command module 230 may reflect such vehicle user behaviors in the preference map for the vehicle selection administration area by giving the shaded areas a higher value.

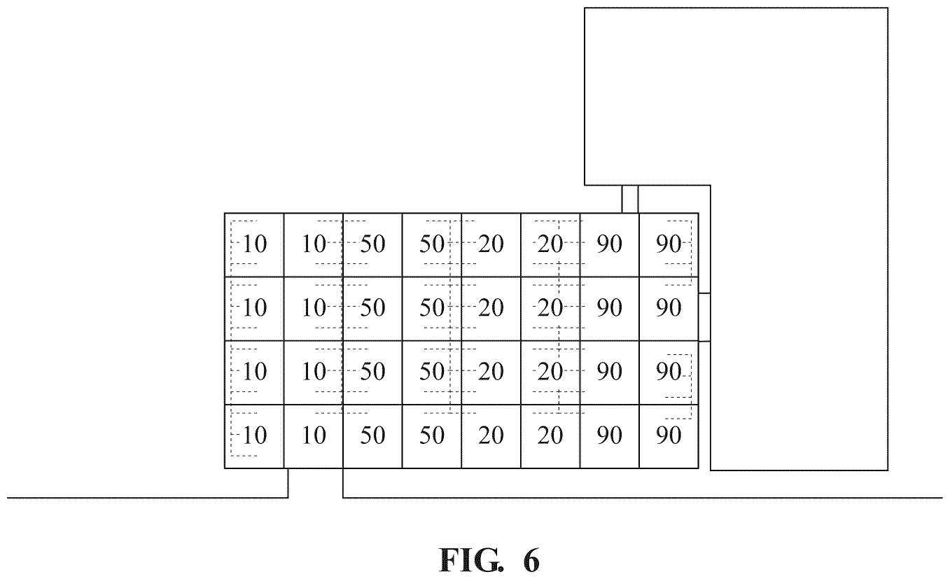

In some embodiments, command module 230 may adjust a preference map based on which vehicles are chosen by vehicle users. For instance, if vehicle users are regularly walking past electric vehicles located where the preference map has the highest values to less environmentally friendly vehicles located behind such electric vehicles, command module 230 may adjust the preference map such that the less environmentally friendly vehicles are placed even further away from the electric values. For example, in order to further separate the more and less desirable vehicles, command module 230 may place a region of low values within the preference map between areas of higher preference in the preference map as shown in FIG. 6.

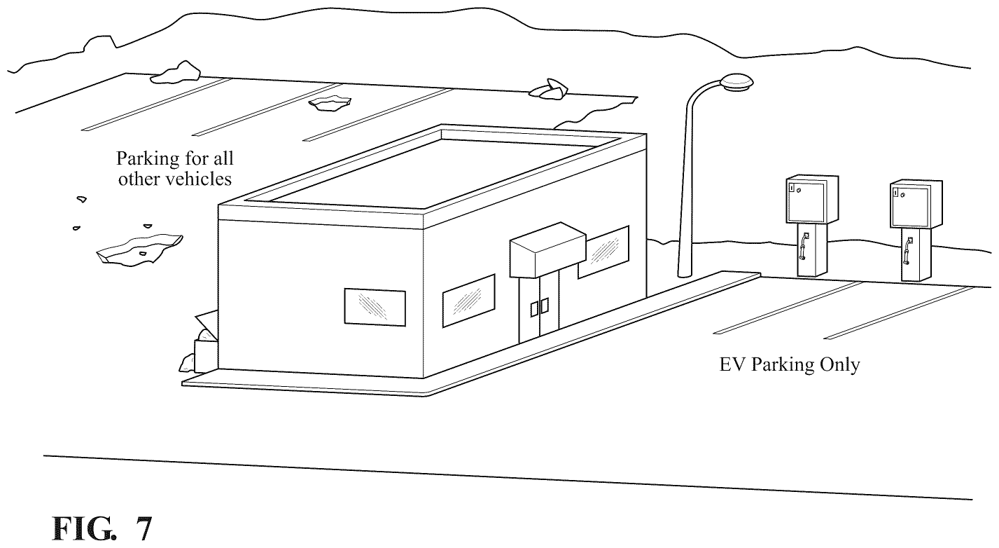

When a vehicle is within a vehicle selection administration area, command module 230 may determine the location in which the vehicle should be parked or stand by according to a vehicle selection strategy as described herein. For example, as shown in FIG. 7 a vehicle selection strategy may determine that only electric vehicles may be parked or stand by on a driveway between a structure and a street, whereas any gasoline or diesel vehicle must be parked in the rear lot behind the structure. In this manner, a vehicle selection strategy can operate within a vehicle selection administration area to encourage or discourage vehicle usage by selecting where a vehicle is allowed to park or stand by.

In some embodiments, command module 230 may include restrictions within a preference map. For example, command module 230 may record in a preference map that only electrical vehicles may park or stand by where the value(s) of preference map exceed a threshold (e.g., preference map value>75). By use of multiple thresholds, a preference map may be separated into different regions for different vehicle types (e.g., a first region for electric vehicles only, a second region for hybrids and electric vehicles only, and a third region without any vehicle type restriction) or based on other vehicle characteristics or associated measurements (e.g., vehicle capacity, vehicle weight, cumulative environmental impact for a period of time).

In one embodiment, command module 230 may determine an environmental impact for a vehicle for a given period of time, such as by tracking the estimated or actual carbon emissions associated with the vehicle. Command module 230 may use any model, function, or method known in the art to determine the environmental impact for a vehicle, including models, functions, or methods known to utilize machine learning. Accordingly, command module 230 may provide summaries of environmental impact of vehicles to vehicle users. In some embodiments, command module 230 may also use data regarding the environmental impact of vehicles to estimate the environmental impact for a period of time of a vehicle user, a group of vehicle users (e.g., a household), a group of vehicles, etc. In some embodiments, command module 230 environmental budgets may be received for vehicles, groups of vehicles, vehicle users, or groups of vehicle users, such that command module 230 uses vehicle selection strategies described herein to try and stay within such budgets.

In some embodiments, based on the environmental impact of a vehicle, a vehicle preference score associated with the vehicle may be adjusted by command module 230 (e.g., as the environmental impact of the vehicle increases, the vehicle's preference score may decrease). In this manner, vehicles with higher environmental impact when operated may more quickly decrease in terms of their vehicle preference scores as opposed to vehicles with a lower environmental impact. In some embodiments, command module 230 may utilize a preference score associated with a vehicle to determine where it may park or stand by in relation to a preference map. For instance, command module 230 may use a function that relies on a value within the preference map and the vehicle's preference score to determine if it may park or stand by in a particular location (e.g., is preference map value combined with the preference score above a pre-defined threshold). In some embodiments, a vehicle having a vehicle preference score of a particular value or below a particular value may be made unavailable by command module 230 (e.g., by locking the vehicle, placing it in a restricted area), such as where environmental restrictions do not allow the vehicle to be operated (e.g., not allowed when an air pollution advisory/warning is active).

By utilizing vehicle preference scores in conjunction with a preference map to determine where vehicles may park or stand-by, command module 230 may achieve higher success with vehicle users choosing environmentally friendly vehicles. This may occur because vehicle users under such an approach may feel their vehicle choices reflect what becomes available to them over time, as opposed to an approach where vehicle users may feel that only the most environmentally friendly vehicles are always being “pushed” on them. In some embodiments, command module 230 may reset the preference score of a vehicle (e.g., to an initial default value for that vehicle) on a scheduled basis (e.g., weekly). In some embodiments, command module 230 may also adjust preference scores in response to particular events. For example, a convertible sports car may receive an increase to its preference score on sunny weekend days, which is then offset by a decrease at other times. As another example, command module 230 may receive information that a particular pollutant is to be avoided, such that command module 230 adjusts the vehicle preference scores of vehicles that may generate such a pollutant to discourage their usage. As yet another example, command module 230 may receive information relating to when clean grid power is expected to be available for charging electric vehicles or the environmental impact of charging at various times of the day, week, etc. Accordingly, if selection of an electric vehicle would likely result in the need of charging from “dirty power” (e.g., energy derived from coal-based power), command module 230 may adjust vehicle preference scores such that electric vehicle selection is disfavored in comparison to other selection of other vehicles that may be estimated to be more environmentally friendly within such a context, such as hybrid vehicles, hydrogen-fueled vehicles, etc.

In some embodiments, vehicle preference scores may be time-varying or be adjusted separately for vehicle users. For example, a member of a household who performs construction work may need access to particular vehicles that other members of the household do not require. As another example, command module 230 may determine based on estimated routes of a vehicle user that certain vehicles should or should not be favored for selection. For instance, if a member of the household, who also happens to be an early riser, is estimated by command module 230 to travel to work through a ultra-low emissions zone, command module 230 may adjust vehicle preference scores in the early morning that favor electric vehicles for when the vehicle user is expected to depart, which may then be removed once the vehicle user selects a vehicle and departs.

In some embodiments, command module 230 may implement selection deterrence actions as part of a vehicle selection strategy. A selection deterrence action is an action (or instruction causing such action) that causes additional difficulty or discomfort in selecting a disfavored vehicle by a vehicle user (independent of where the disfavored vehicle is positioned in a vehicle selection administration area). Examples of a selection deterrence action may include: closing a garage door that provides access to disfavored vehicle, which otherwise would normally be open; locking the disfavored vehicle, which otherwise would normally be unlocked; adjusting response times of the disfavored vehicle, such as increasing a startup time, decreasing the response rate of the human user interface, etc. ; adjusting climate controls or seat settings so that the disfavored vehicle is uncomfortable upon entry by the vehicle user; adjusting the orientation of the disfavored vehicle contrary to a vehicle user preference (e.g., parked facing in rather than facing out); setting the infotainment system to audio content contrary to a vehicle user preference (e.g., heavy metal or rap music instead of classical music or jazz); and so on. In some embodiments, a selection deterrence action may restrict vehicle functions when it is designated as a disfavored vehicle, such as where access to functions of the infotainment (e.g., no radio), ADAS (e.g., no cruise control or lane keeping assistance), climate control (e.g., no air conditioning), or other systems are denied or impaired. As another example, a selection deterrence action may restrict vehicle performance, such as limiting speed, acceleration, handling, or other characteristics so as to make operating the disfavored vehicle less enjoyable to operate. In some embodiments, a selection deterrence action may be prevented from being implemented or continuing to remain in effect, such as where the vehicle user instructs command module 230 that an emergency condition exists.

In some embodiments, command module 230 may evaluate whether a vehicle selection strategy was effective. For example, command module 230 may utilize outcomes such as whether an undesired vehicle was avoided; whether a climate budget was met for a vehicle, group of vehicles, a vehicle user, or a group of vehicle users; and so on to evaluate the effectiveness of a vehicle selection strategy. Based on command module 230's evaluation of the effectiveness of a vehicle selection strategy, command module 230 may adjust an estimated probability of success associated with the vehicle selection strategy. In some embodiments, command module 230 may utilize machine learning to evaluate the estimated probability of success of a vehicle selection strategy. Once an estimated probability of success is obtained for a vehicle selection strategy, command module 230 may share that information via vehicle selection database 400, such that the most successful vehicle selection strategies may be employed across multiple vehicle selection administration areas by multiple instances of the systems and methods described herein.

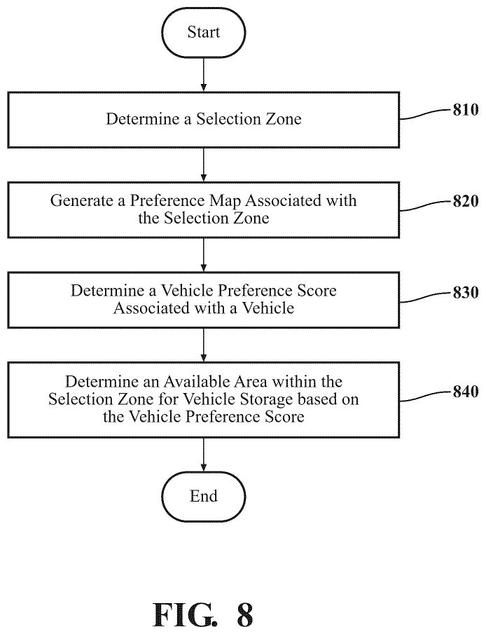

FIG. 8 illustrates a flowchart of a method 800 that is associated with using vehicle selection strategies. Method 800 will be discussed from the perspective of the vehicle selection system 170 of FIGS. 1 and 2. While method 800 is discussed in combination with the vehicle selection system 170, it should be appreciated that the method 800 is not limited to being implemented within vehicle selection system 170 but is instead one example of a system that may implement method 800.

At step 810, command module 230 may determine a selection zone. For example, a household may wish to use its driveway as a selection zone (or vehicle selection administration zone as described herein). Accordingly, household members may instruct the vehicle or use smartphone maps to determine the edges of the driveway and any additional area desired (e.g., a garage) to form the selection zone.

At step 820, command module 230 may generate a preference map associated with the selection zone. For example, command module 230 may determine that areas closest to the house to an entrance (e.g., front door, garage door) have the highest preference and thus should have a high value within the preference map, whereas other areas should have lesser values.

At step 830, command module 230 may determine a vehicle preference score associated with a vehicle. For example, the household may have an electric vehicle, a hybrid, and a gas-powered sports car. Accordingly, command module 230 may assign the electric vehicle with the highest vehicle preference score (e.g., 99), the hybrid with the second highest preference score (e.g., 80) and the gas-powered sports car with the lowest preference score (e.g., 40). As the vehicles are selected and operated by household members, command module 230 may adjust the vehicle preference scores in relation to each vehicle's estimated environmental impact.

At step 840, command module 230 may determine an available area within the selection zone for vehicle storage based on the vehicle preference score. For example, if all three vehicles described in the paragraph above are at the same selection zone, command module 230 may instruct the electric vehicle to park in the area having the highest values in the preference map, instruct the hybrid to park in the area having the next highest values in the preference map not taken by the electric vehicle, and the gas-powered sports car to park in the area having the lowest values in the preference map (e.g., because it's vehicle preference score is below a threshold). In some embodiments, the determination of an available area within the selection zone may occur whenever a vehicle enters a selection zone. In some embodiments, the determination of an available area within the selection zone may occur whenever command module 230 determines it should update the location of vehicles within a selection zone (e.g., 15 minutes after a vehicle has parked, 20 minutes prior to an estimated departure for a household member).

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, vehicle selection system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, vehicle selection system 170, automated driving module(s) 160, or any combination thereof may control some or all of these vehicle system(s) 140 and, thus, may be partially or fully autonomous.

Processor(s) 110, vehicle selection system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, vehicle selection system 170, automated driving module(s) 160, or any combination thereof may control the direction, speed, or both of vehicle 100. Processor(s) 110, vehicle selection system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with vehicle selection system 170may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of. and.” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

1. A system, comprising:
a processor; and
a memory communicably coupled to the processor and storing machine-readable instructions that, when executed by the processor, cause the processor to:
determine a selection zone;
generate a preference map associated with the selection zone;
determine a vehicle preference score associated with a vehicle capable of being adjusted in value as characteristics of the vehicle are evaluated;
determine an available area within the selection zone for vehicle storage based on the vehicle preference score; and
autonomously park the vehicle within the available area.

2. The system of claim 1, wherein the machine-readable instructions to determine the vehicle preference score includes setting the vehicle preference score to an initial value based on a fuel source of the vehicle.

3. The system of claim 1, wherein the machine-readable instructions to determine the vehicle preference score includes adjusting the vehicle preference score based on a measure of an environmental impact of the vehicle for a period of time.

4. The system of claim 1, wherein the machine-readable instructions to determine the vehicle preference score includes adjusting the vehicle preference score based on an estimated environmental impact of electrical vehicle charging.

5. The system of claim 1, wherein the machine-readable instructions to determine the vehicle preference score includes adjusting the vehicle preference score based on an expected route of a vehicle user.

6. The system of claim 1, wherein the machine-readable instructions that, when executed by the processor, further includes causing the processor to:
implement a selection deterrence action on the vehicle.

7. The system of claim 6, wherein the machine-readable instructions to implement the selection deterrence action on the vehicle limits a performance characteristic of the vehicle.

8. A non-transitory computer-readable medium including instructions that when executed by one or more processors cause the one or more processors to:
determine a selection zone;
generate a preference map associated with the selection zone;
determine a vehicle preference score associated with a vehicle capable of being adjusted in value as characteristics of the vehicle are evaluated;
determine an available area within the selection zone for vehicle storage based on the vehicle preference score; and
autonomously park a vehicle within the available area.

9. The non-transitory computer-readable medium of claim 8, wherein the instruction to determine the vehicle preference score includes setting the vehicle preference score to an initial value based on a fuel source of the vehicle.

10. The non-transitory computer-readable medium of claim 8, wherein the instruction to determine the vehicle preference score includes adjusting the vehicle preference score based on a measure of an environmental impact of the vehicle for a period of time.

11. The non-transitory computer-readable medium of claim 8, wherein the instruction to determine the vehicle preference score includes adjusting the vehicle preference score based on an estimated environmental impact of electrical vehicle charging.

12. The non-transitory computer-readable medium of claim 8, wherein the instruction to determine the vehicle preference score includes adjusting the vehicle preference score based on an expected route of a vehicle user.

13. The non-transitory computer-readable medium of claim 8, wherein the instructions further include to:
implement a selection deterrence action on the vehicle.

14. A method, comprising:
determining a selection zone;
generating a preference map associated with the selection zone;
determining a vehicle preference score associated with a vehicle capable of being adjusted in value as characteristics of the vehicle are evaluated;
determining an available area within the selection zone for vehicle storage based on the vehicle preference score; and
autonomously parking a vehicle within the available area

15. The method of claim 14, wherein determining the vehicle preference score includes setting the vehicle preference score to an initial value based on a fuel source of the vehicle.

16. The method of claim 14, wherein determining the vehicle preference score includes adjusting the vehicle preference score based on a measure of an environmental impact of the vehicle for a period of time.

17. The method of claim 14, wherein determining the vehicle preference score includes adjusting the vehicle preference score based on an estimated environmental impact of electrical vehicle charging.

18. The method of claim 14, wherein determining the vehicle preference score includes adjusting the vehicle preference score based on an expected route of a vehicle user.

19. The method of claim 14, further comprising:
implementing a selection deterrence action on the vehicle.

20. The method of claim 19, wherein implementing the selection deterrence action on the vehicle limits a performance characteristic of the vehicle.
